(19) United States
(12) Patent Application Publication
(10) Pub. No.: US 2008/0005575 A1
(43) Pub. Date: Jan. 3, 2008

(54) Mobile phone locking system using multiple biometric factors for owner authentication

(75) Inventors: Vinod Kumar Choyi, Ottawa (CA); Bertrand Marquet, Le Plessis Robinson (FR)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/477,613

(22) Filed: Jun. 30, 2006

(51) Int. Cl. H04L 9/00

(52) U.S. Cl. 713/182

(57) ABSTRACT

A method and apparatus are provided for authenticating a user of a mobile phone. While the user holds the phone to his or her ear, a microphone near the earpiece emits clicks into the user's ear. The speaker of the phone measures the response from the ear as an otoacoustic signal. A processor digitizes the measured otoacoustic signal to produce a received digital otoacoustic signature, and compares this with a stored digital otoacoustic signature of a legitimate user. If the signatures match, the phone is enabled. The invention allows secure authentication of mobile phones in a manner very natural and convenient to users.

### FIELD OF THE INVENTION

The invention relates to security locking of communication devices, and more particularly to biometric authentication of mobile communication devices having phone capability.

### BACKGROUND OF THE INVENTION

A concern in the mobile phone market is theft or loss of mobile phones. Subscribers of those stolen or lost phones do not want to have them used by a third person and have the unauthorized calls billed to their subscription. Smart phones are a particular type of mobile phone which include PDA functionality and other functionality which store personal or valuable information. Theft or loss of smart phones therefore also gives rise to the possibility of fraud or information theft, such as theft of banking information, passwords, and address books.

Currently, some mobile phones provide security against such unauthorized use by requiring a user to enter a password such as a text string or a PIN (personal identification number) using the keypad of the phone. The mobile phone is locked against use until the user enters the correct password. In order to maximize security, such a mobile phone should require a user to enter the password often, such as every time the phone is used, and the password should be long. In practice, for the sake of convenience users often select weak passwords. The phone may also require the password to be entered only when the phone is turned on and not every time the phone is used, saving the owner from having to enter the password frequently. While this is far more convenient to the user since phones are often left on, it means that if a phone is stolen or lost while turned on then the locking mechanism is bypassed.

### SUMMARY OF THE INVENTION

In accordance with one aspect of the invention, a method is provided for authenticating a user of a portable communication device having a phone capability. A trigger signal is emitted through a speaker of the portable communication device. A received signal is received through an otoacoustic microphone of the portable communication device. A generated digital otoacoustic signature is generated from the received signal. The generated digital otoacoustic signature is compared with each of at least one stored digital otoacoustic stored in a memory of the portable communication device. If the generated digital otoacoustic signature matches one of the stored digital otoacoustic signatures, the portable communication device is unlocked.

In accordance with another aspect of the invention, a portable communication device having a phone capability and an authentication feature is provided. The portable communication device includes a speaker, an otoacoustic microphone, a memory for storing at least one stored digital otoacoustic signature, and an authenticator. The authenticator includes means for transmitting a trigger signal through the speaker, means for receiving a received signal through the otoacoustic microphone, a digitizer for generating a generated digital otoacoustic signature from the received signal, means for comparing the generated digital otoacoustic signature with at least one stored digital otoacoustic signature stored in the memory, and means for unlocking the portable communication device if the generated digital otoacoustic signature matches any of the stored digital otoacoustic signatures.

Apparatus are provided for carrying out the methods of the invention. The methods of the invention may be stored as processing instructions on computer-readable media.

The methods and apparatus of the present invention allow biometrics to be used in a natural way to provide authentication of legitimate users of a mobile phone. In ideal use, the stored digital otoacoustic signature read from memory during authentication is that of the legitimate subscriber. If the phone is being properly used, the trigger signal will enter the ear canal of a user, and the resulting echoes will enter the microphone as the received signal. Only if digitization of this received signal produces a digital signature matching that stored in memory, that is if the phone is being used by a legitimate subscriber, will the user be authenticated and the phone unlocked (although in one embodiment a failed match can be bypassed by manual entry of a password). The use of an otoacoustic signature provides two advantages. First, a high level of reliability is achieved in identifying a legitimate owner, due to the extreme difficulty in reproducing such signatures and the extremely low probability that two individuals will have the same otoacoustic signatures. Second, measurement of an otoacoustic signature requires very natural movement on the part of a mobile phone user since a speaker is placed next to the ear. Authentication may be carried out with no active action on the part of the user, since the user holds the measurement apparatus to his or her ear anyway while using a mobile phone.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of a mobile phone according to one embodiment of the invention;

FIG. 2 is a diagram of an authenticator within the mobile phone of FIG. 1 according to one embodiment of the invention; and

FIG. 3 is a flowchart of a method carried out by the authenticator of FIG. 2 according to one embodiment of the invention.

It will be noted that in the attached figures, like features bear similar labels.

### DETAILED DESCRIPTION OF THE EMBODIMENTS

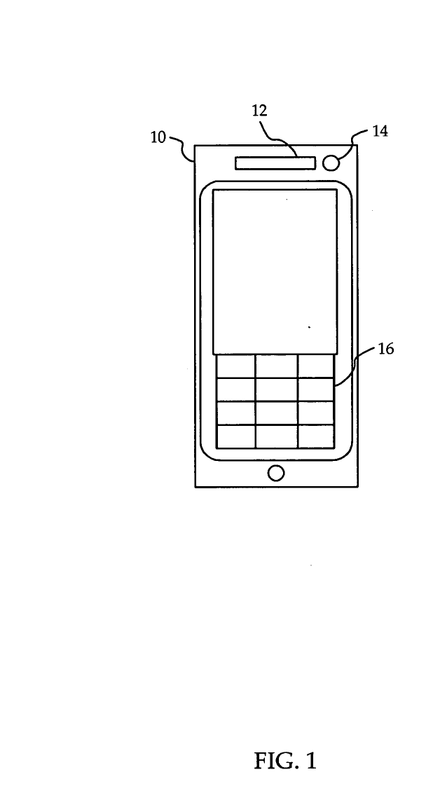

Referring to FIG. 1, a mobile phone 10 according to one embodiment of the invention is shown. The mobile phone 10 includes a speaker 12, and an otoacoustic microphone 14 located next to the speaker 12. Ergonomically, the speaker 12 and the otoacoustic microphone 14 are located on the mobile phone 10 such that they can transmit sound into and detect sound from the ear canal of a user when the user holds the mobile phone 10 to his or her head in normal usage of the phone. The mobile phone 10 may also include a keypad 16.

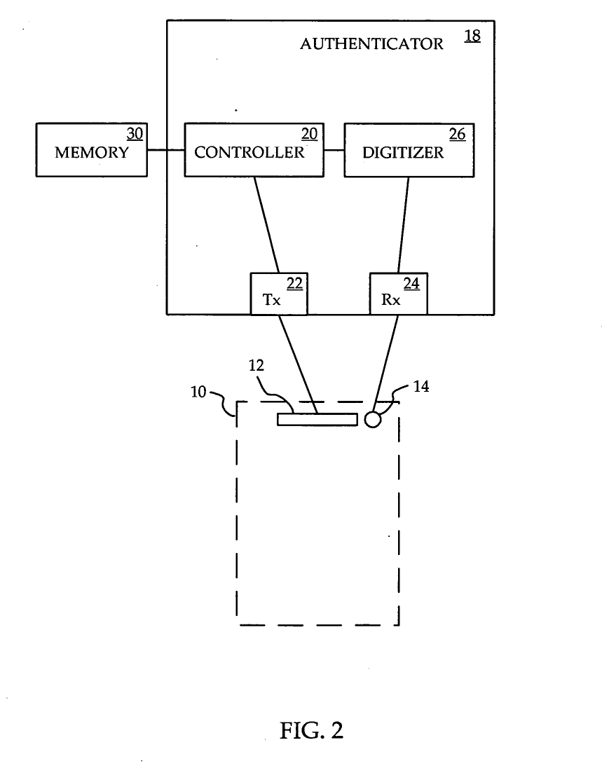

Referring to FIG. 2, an authenticator according to one embodiment of the invention is shown. The authenticator 18 is located within the mobile phone 10. The authenticator 18 is preferably in the form of software loaded as instructions into a processor within the mobile phone. Alternatively, the authenticator may be in the form of hardware, such as an integrated circuit, within the phone. More generally, the authenticator contains logical instructions in the form of any combination of software or hardware. Logical instructions in the form of software may be stored on a computer-readable medium for loading into a processor within the mobile phone.

The authenticator 18 includes a controller 20, a transmitter 22, a receiver 24, and a digitizer 26. The controller 20 has access to a memory 30. In FIG. 2 the memory is outside the authenticator and for general use by other functionality of the mobile phone. Alternatively, the memory 30 may be within the authenticator 18 or dedicated to the authenticator 18. The memory 30 stores a stored digital otoacoustic signature. In practice this should be the mobile phone owner's otoacoustic signature. When a mobile phone is purchased by an owner, an otoacoustic signature reader (which includes a speaker and microphone combination, and a recorder) at the point of purchase is used to record the owner's otoacoustic signal determined as the echo of a series of clicks transmitted into the user's ear canal, to digitize the otoacoustic signal, and store the result as a stored digital otoacoustic signature within the memory 30 of the mobile phone. An example of a method by which the owner's otoacoustic signal may be measured and digitized into a digital otoacoustic signature is given in Swabey, M., Beeby, S., Brown, A. and Chad, J., “Using Otoacoustic Emissions as a Biometric”, in Proceedings of First International Conference on Biometric Authentication (ICBA 2004), pp. 600-606, Hong Kong. Zhang, D. and Jain, A. N., Eds., incorporated by reference herein.

The transmitter 22 is preferably the transmitter used by other functionality of the mobile phone, such as transmission of a received communication signal to the speaker, but may alternatively be dedicated to the authenticator 18.

Broadly, in operation the authenticator 18 generates a trigger signal which is transmitted through the speaker 12. The authenticator 18 receives a received signal through the otoacoustic microphone 14 and generates a generated digital otoacoustic signature from the received signal. The authenticator compares the generated digital otoacoustic signature with each of at least one stored digital otoacoustic signature stored in memory 30. If the generated digital otoacoustic signature matches one of the at least one stored digital otoacoustic signature, then the user is authenticated and the mobile phone is unlocked.

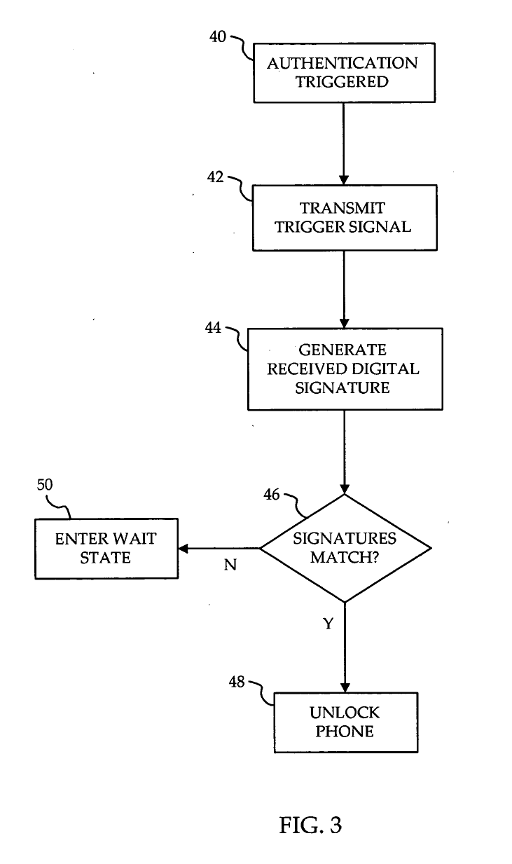

Referring to FIG. 3, a flowchart of an authentication method carried out by the authenticator of FIG. 2 according to one embodiment of the invention is shown. At step 40 the authenticator is triggered. The authenticator is triggered whenever authentication of the user is desired, depending on the design of the mobile phone. Possible means of triggering the authenticator include when the phone is turned on, when a key or key combination or key sequence on the keypad 16 is pressed, when the SEND button is pressed in order to make an outgoing call, or when the OFFHOOK button is pressed in order to receive an incoming call. The methods by which the authenticator can be triggered will depend on the particular implementation of the invention within the mobile phone. Any combination of triggering methods may also be used. For example, turning on the mobile phone may trigger the authenticator to prevent unauthorized access to stored information. The authenticator may also be triggered, on the same phone, when a user attempts to make an outgoing call or to receive an incoming call. Because operation of the authenticator requires no input from a user other than normal placement of the phone's speaker next to the user's ear, there is no inconvenience to the user from repeated authentications.

At step 42 the controller 20 instructs the transmitter 22 to emit a trigger signal, in the form of a series of clicks, through the speaker 12. At step 44 the controller 20 instructs the digitizer 26 to generate a generated digital otoacoustic signature from a received signal, the received signal having been received through the otoacoustic microphone 14 and the receiver 24. The authenticator may use several seconds worth of received signal to generate the generated digital otoacoustic signature, in order to give the user sufficient time to raise the mobile phone, and hence the otoacoustic microphone 14 and speaker 12, to the user's ear after triggering the authenticator. At step 46 the controller 20 compares the generated digital otoacoustic signature with the stored digital otoacoustic signature stored in memory 30, and determines whether the two digital otoacoustic signatures match. If the digital otoacoustic signatures match, then at step 48 the authenticator unlocks the mobile phone.

The effect of unlocking of the mobile phone will depend on the cause of the triggering of the authenticator, which will depend in turn on the particular implementation of the invention. If the authenticator was triggered because the phone was turned on, then unlocking the phone will enable normal functionality and, if the phone is a smart phone, access to stored information. If the authenticator was triggered because the SEND button was pressed, the dialed digits will be transmitted. If the authenticator was triggered because the OFFHOOK button was pressed in response to an incoming call, the incoming call will be enabled.

If the authenticator determines at step 46 that the digital otoacoustic signatures do not match, then the corresponding action will not be executed. For example, access to stored information will not be granted, or dialed digits will not be transmitted. The authenticator enters a wait state at step 50, and waits for authentication to be triggered again. The user may then attempt to trigger the authenticator again by repeating the triggering event. The authenticator may be configured to only allow a specified number of authentication attempts, after which authentication may only be effected by manual entry of a password.

It is possible, however, that the authenticator is unable to receive a received signal and corresponding digital otoacoustic signature which match the digital otoacoustic signature stored in memory, even from a legitimate user. This may be the case if the user's ear canal is partially obstructed due to illness. In one embodiment, the user may bypass the otoacoustic-based authenticator 18 by entering a password. Because this bypassing will be carried out only rarely, if ever, the password may be lengthy and therefore very secure without being of great inconvenience to the user.

The invention has been described with reference to a mobile phone. More generally, the invention may be implemented in any portable communication device having a phone capability, such as a smart phone, or a personal digital assistant having a phone capability.

The invention has been described in which the digital otoacoustic signature of the owner is recorded at the point of purchase. Alternatively, the digital signature of the owner may be recorded by the phone itself. In such an embodiment, the mobile phone includes an otoacoustic recorder comprising logical instructions for interfacing this functionality with the user and for storing a stored digitized otoacoustic signature in the memory 30 of the phone. However, the otoacoustic microphone 14, speaker 12, and digitizer 26 may be the same as those used by the authenticator.

The invention has been described as storing a single stored digital otoacoustic signature in the memory 30. Alternatively, a number of digital signatures may be stored in the memory 30. This would allow more than one legitimate user to be defined for the mobile phone. The additional digital otoacoustic signatures may be recorded at the point of purchase, or by an otoacoustic recorder within the phone. If the phone includes an otoacoustic recorder, the functionality to add or remove digital signatures may be locked until the password is entered. A primary digital signature may also be defined at the time of purchase, and the functionality to add or remove legitimate digital otoacoustic signatures may be locked until an otoacoustic signal corresponding to the primary digital otoacoustic signature is detected. This allows a mobile phone to be shared by several people, such as a family, with one person maintaining ultimate control over the allowed users.

The embodiments presented are exemplary only and persons skilled in the art would appreciate that variations to the embodiments described above may be made without departing from the spirit of the invention. The scope of the invention is solely defined by the appended claims.

We claim:

1. A method of authenticating a user of a portable communication device having a phone capability, comprising:
emitting a trigger signal through a speaker of the portable communication device;
receiving a received signal through an otoacoustic microphone of the portable communication device;
generating a generated digital otoacoustic signature from the received signal;
comparing the generated digital otoacoustic signature with each of at least one stored digital otoacoustic signature stored in a memory of the portable communication device; and
if the generated digital otoacoustic signature matches one of the at least one stored digital otoacoustic signature, unlocking the portable communication device.

2. The method of claim 1 wherein the otoacoustic microphone is located next to the speaker, such that the received signal is generated by echo of the trigger signal when the speaker and otoacoustic microphone are held to a user's ear.

3. The method of claim 1 further comprising unlocking the portable communication device if a password is entered via a keypad of the portable communication device.

4. The method of claim 1 further comprising recording at least one of the at least one stored digital otoacoustic signature at a point of purchase and storing the at least one recorded digital otoacoustic signature within the memory.

5. The method of claim 1 further comprising:
reading a new digital otoacoustic signature;
identifying the new digital otoacoustic signature as a legitimate digital otoacoustic signature; and
storing the new digital otoacoustic signature in the memory as a stored digital otoacoustic signature.

6. The method of claim 5 wherein one stored digital otoacoustic signature is a primary digital otoacoustic signature, and wherein identifying the new digital otoacoustic signature as legitimate is only allowed if the portable communication device is first authenticated with respect to the primary digital otoacoustic signature.

7. A portable communication device having a phone capability and having an authentication feature, the portable communication device comprising:
a speaker;
an otoacoustic microphone;
a memory for storing at least one stored digital otoacoustic signature; and
an authenticator comprising:
means for transmitting a trigger signal through the speaker;
means for receiving a received signal through the otoacoustic microphone;
a digitizer for generating a generated digital otoacoustic signature from the received signal;
means for comparing the generated digital otoacoustic signature with at least one stored digital otoacoustic signature stored in the memory; and
means for unlocking the portable communication device if the generated digital otoacoustic signature matches one of the at least one stored digital otoacoustic signature.

8. The portable communication device of claim 7 wherein the otoacoustic microphone and the speaker are located in proximity such that an echo of a signal transmitted through the speaker will be detected by the otoacoustic microphone when the portable communication device is held to a user's ear.
